(19) United States
(12) Patent Application Publication
(10) Pub. No.: US 2025/0388247 A1
(43) Pub. Date: Dec. 25, 2025

(54) ESTIMATING DEVICE AND METHOD FOR DETERMINING ESTIMATED MOVEMENT VALUES

(71) Applicant: Siemens Mobility GmbH, München (DE)

(72) Inventors: Steffen Jennek, Neuried (DE); Michael Sollfrank, München (DE); Maximilian Walz, Röbersdorf (DE)

(21) Appl. No.: 18/879,904

(22) PCT Filed: Jun. 12, 2023
(86) PCT No.: PCT/EP2023/065625

§ 371 Date: Dec. 30, 2024

(30) Foreign Application Priority Data
Jun. 29, 2022 (DE) 10 2022 206 618.9

(51) Int. Cl. B61L 25/02; B61K 9/02

(52) U.S. Cl. CPC B61L 25/021; B61K 9/02

(57) ABSTRACT

An estimating device for determining a new estimated movement value, which indicates the speed of a rail vehicle. A Kalman filter is supplied on the input side with at least torque values, vertical force values, wheel size values, and wheel speed values. Based on these values, and based on a Kalman filtering, the filter determines a Kalman estimated vehicle speed value. A slip module, which is supplied on the input side with the torque values, the wheel size values, the wheel speed values, and the respective previous estimated movement value of the estimating device, determines a wheel circumferential speed value and a sliding indication, which indicates any sliding of the respective axle. An evaluation module determines the new estimated movement value of the estimating device on the basis of the Kalman estimated vehicle speed value, the wheel circumferential speed value, and the sliding indications.

In the domain of railway technology, a relatively accurate determination of the velocity of rail vehicles is of great significance in order to be able to take account of the now typical requirements placed upon operators.

The object underlying the invention is to specify an estimating device with which the estimated movement values which define the movement of a rail vehicle can be determined with a relatively high level of accuracy.

This object is achieved according to the invention by way of an estimating device having the features of claim 1. Advantageous embodiments of the estimating device according to the invention are disclosed in the subclaims.

Thereafter, it is provided that an estimating device for determining a new estimated movement value which indicates the speed of a rail vehicle having at least two axles, wherein the estimating device comprises
a Kalman filter which is supplied on the input side at least with torque values, vertical force values, wheel size values and wheel rotary speed values and on the basis thereof and on the basis of a Kalman filtration, determines a Kalman-estimated vehicle speed value,
a slip module that is supplied on the input side with the torque values, the wheel size values, the wheel rotary speed values and the respective prior estimated movement value from the estimating device and determines a wheel circumferential speed value and a sliding indication which indicates any sliding of the respective axle, and
an evaluating module which determines the new estimated movement value of the estimating device on the basis of the Kalman-estimated vehicle speed value, the wheel circumferential speed value and the sliding indications.

A substantial advantage of the estimating device according to the invention is that, with the Kalman filter provided according to the invention in combination with the slip module according to the invention and with little hardware effort and time expenditure, highly accurate estimated movement values that can be used for the operation of the rail vehicle can be determined.

With regard to the slip module, it is regarded as advantageous if, during a braking operation of the rail vehicle and no sliding of all the axles, the slip module outputs the wheel circumferential speed value of the axle with the highest wheel circumferential speed value to the evaluating module and during a driving operation and no sliding of all the axles, outputs the wheel circumferential speed value of the axle with the smallest wheel circumferential speed value to the evaluating module, and during sliding of all the axles, outputs an all-sliding indication to the evaluating module.

With regard to the evaluating module, it is regarded as advantageous if, during a braking operation of the rail vehicle and no sliding of all the axles, the evaluating module outputs the wheel circumferential speed value of the axle with the highest wheel circumferential speed value as the new estimated movement value, and during a driving operation and no sliding of all the axles, outputs the wheel circumferential speed value of the axle with the smallest wheel circumferential speed value as the new estimated movement value, and during sliding of all the axles, determines the new estimated movement value on the basis of the Kalman-estimated vehicle speed value of the Kalman filter.

It is advantageous if the estimating device has a vertical force calculating module which generates, at least on the basis of the torque values that are also used by the Kalman filter, the wheel size values and the respective prior estimated movement value of the estimating device, a vertical force value per axle, wherein each of the vertical force values from the vertical force calculating module forms one of the vertical force values that are used by the Kalman filter.

It is also advantageous if the estimating device has a friction braking torque calculating module which generates, at least on the basis of a braking pressure value per axle, the wheel size values and the respective prior estimated movement value of the estimating device, a friction braking torque value per axle, wherein each of the friction braking torque values forms one of the torque values that is used by the Kalman filter.

The Kalman filter preferably also uses axle-related motor torque values as torque values or at least takes account thereof.

The Kalman filter is preferably an extended Kalman filter.

The estimating device preferably outputs, as a further estimated movement value, a vehicle acceleration value indicating the acceleration of the rail vehicle.

Furthermore, it is regarded as advantageous if the Kalman filter also determines a traction value per axle relating to the force-rail contact and the estimating device additionally outputs the traction values.

The estimating device preferably comprises a computing device and a memory store in which are stored: a Kalman filter software module which, when executed by the computing device, forms the Kalman filter, a slip software module which, when executed by the computing device, forms the slip module, and an evaluating software module which, when executed by the computing device, forms the evaluating module.

Stored in the memory store is, preferably also, a vertical force calculating software module which, when executed by the computing device, forms the vertical force calculating module.

Stored in the memory store is, preferably also, a friction braking torque calculating software module which, when executed by the computing device, forms the friction braking torque calculating module.

The invention also relates to a rail vehicle that is equipped with an estimating device as described above.

With regard to the advantages of the rail vehicle according to the invention and its advantageous embodiments, reference should be made to the statements above in relation to the estimating device according to the invention and its advantageous embodiments.

Preferably connected to the estimating device is a slip regulator which, by taking account of the estimated traction values per axle, the wheel circumferential speed values and the respective estimated movement value of the estimating device, regulates the slip of the respective axle.

It is also advantageous if a plausibility checking device which carries out, with the estimated movement values from the estimating device, a plausibility check in relation to movement information from other sources is connected to the estimating device.

The invention also relates to a method for determining a new estimated movement value which indicates the speed of a rail vehicle having at least two axles, wherein with the method, at least torque values, vertical force values, wheel size values and wheel rotary speed values are fed into a Kalman filter on the input side and, on the basis thereof and on the basis of a Kalman filtration, a Kalman-estimated vehicle speed value is determined, and with the wheel size values, the wheel rotary speed values and the respectively previously determined estimated movement value per axle, a wheel circumferential speed value and a sliding indication is determined which indicates any sliding of the respective axle and, on the basis of the Kalman-estimated 21 vehicle speed value, the wheel circumferential speed value and the sliding indication, the new estimated movement value is determined.

With regard to the advantages of the method according to the invention and its advantageous embodiments, reference should be made to the statements above in relation to the estimating device according to the invention and its advantageous embodiments.

The invention will now be described in greater detail by reference to exemplary embodiments; in the drawings, by way of example:

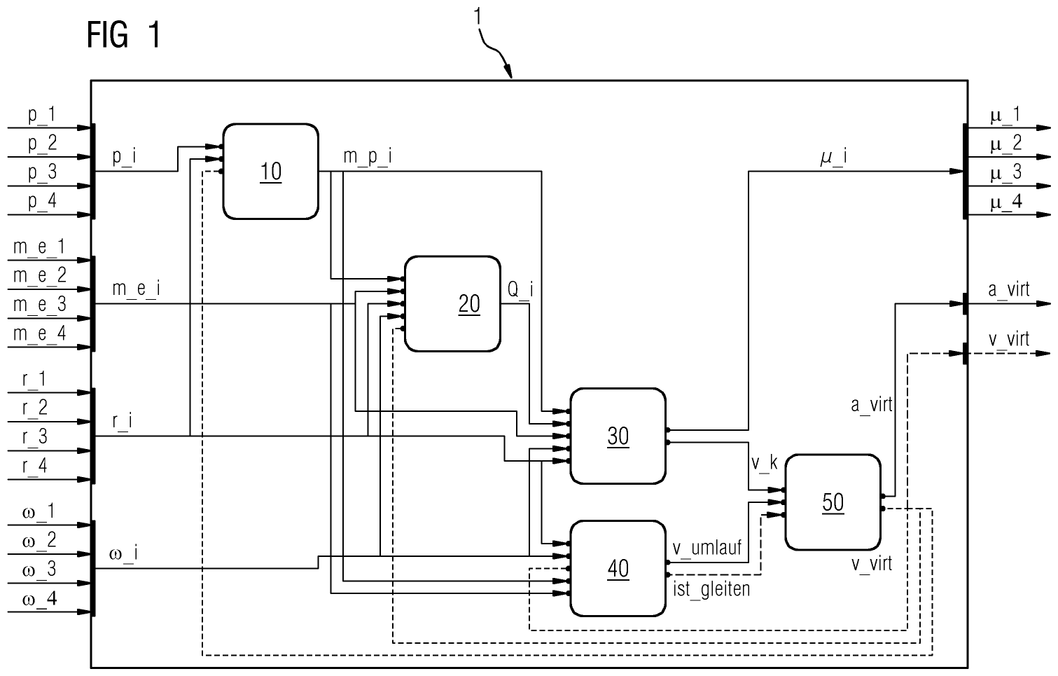

FIG. 1 shows an exemplary embodiment of an estimating device according to the invention in the form of a block circuit diagram,

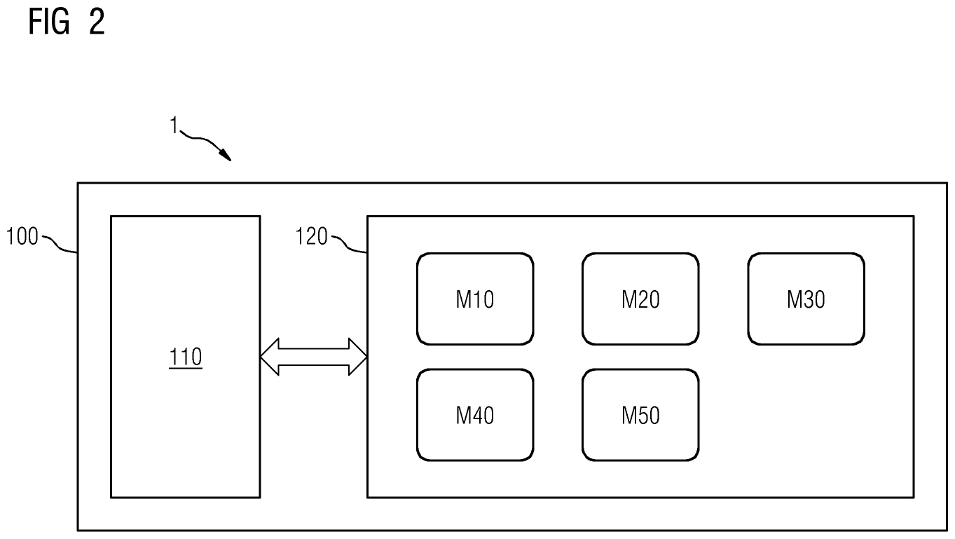

FIG. 2 shows a computing system in which the estimating device according to FIG. 1 is implemented and which accordingly forms the estimating device according to FIG. 1, and

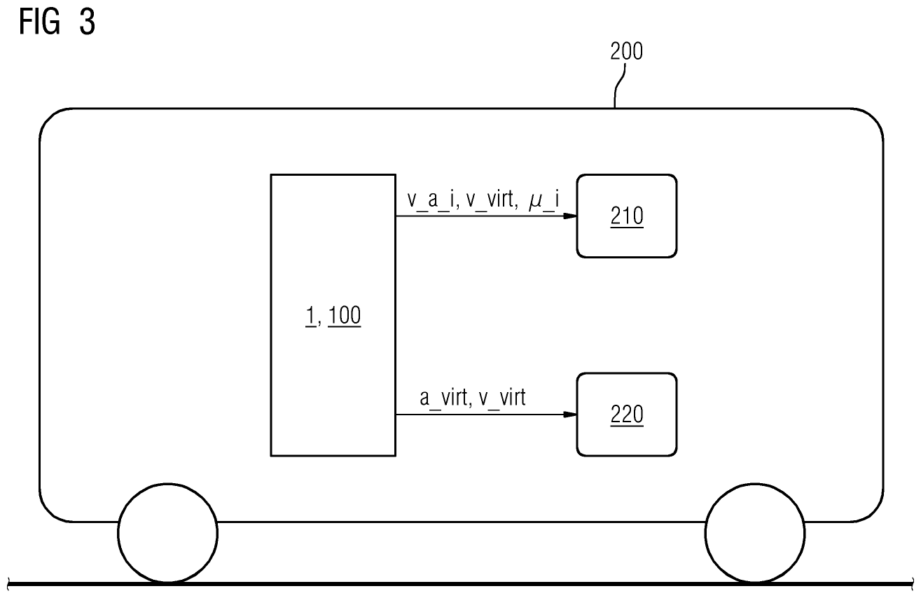

FIG. 3 shows a rail vehicle which is equipped with the estimating device according to FIGS. 1 and 2.

For the sake of clarity, in the drawings, the same reference signs are always used for identical or comparable components.

FIG. 1 shows an exemplary embodiment of an estimating device 1 according to the invention in the form of a block circuit diagram. The estimating device 1 comprises a friction braking torque calculating module 10, a vertical force calculating module 20, an extended Kalman filter 30, a slip module 40 and an evaluating module 50.

The estimating device 1 has inputs for
braking pressure values in the form of brake cylinder pressures p_i,
electrical motor torque values m_e_i (also referred to below as motor torque values),
wheel size values, for example, in the form of dynamic wheel radii r_i, and
wheel rotary speed values) ω_i, which are denoted below as axle rotary speeds.

The index i denotes the respective axle. In the exemplary embodiment of FIG. 1, by way of example, it is assumed that the rail vehicle for which the estimating device is used has four axles, that is that i can have the values between 1 and 4.

The estimating device 1 has inputs for
traction values in the form of coefficients of adhesion μ_i, which define the wheel/rail contact,
a new estimated movement value in the form of an estimated speed value v_virt, and
a new estimated movement value in the form of an estimated acceleration value a_virt.

In the friction braking torque calculating module 10, from the measured brake cylinder pressures p_i, the dynamic wheel radii r_i, geometrical constants (such as the friction radius) and a speed-dependent friction value between the wheel and the brake disk, friction braking torque values m_p_i are calculated for each axle.

In the vertical force calculating module 20, from the friction braking torque values m_p_i, the electric motor torques m_e_i, the dynamic wheel radii r_i, the axle rotary speeds ω_i, known movement resistances, the known mass of the carriage body and known geometry factors, dynamic wheel contact forces Qi are calculated.

The movement resistances F_{w} can be determined approximately by way of empirically derived constants and from the respective vehicle speed.

The Kalman filter 30 is realized on the basis of an observer using regulating technology. Preferably, the movement equations apply to the wheel and the carriage body as the mathematical model according to the following equations (1)-(5):

$$M \ddot{s} - {F}_{w} + {Q}_{1} {μ}_{1} + {Q}_{2} {μ}_{2} + {Q}_{3} {μ}_{3} + {Q}_{4} {μ}_{4} + {F}_{Kupt} \qquad ( 1 )$$

$${I}_{1} {\dot{ω}}_{1} = {m \_ p}_{1} + {Q}_{1} {μ}_{1} {r}_{1} + {m \_ e}_{1} \qquad ( 2 )$$

$${I}_{2} {\dot{ω}}_{2} = {m \_ p}_{2} + {Q}_{2} {μ}_{2} {r}_{2} + {m \_ e}_{2} \qquad ( 3 )$$

$${I}_{3} {\dot{ω}}_{3} = {m \_ p}_{3} + {Q}_{3} {μ}_{3} {r}_{3} + {m \_ e}_{3} \qquad ( 4 )$$

$${I}_{4} {\dot{ω}}_{4} = {m \_ p}_{4} + {Q}_{4} {μ}_{4} {r}_{4} + {m \_ e}_{4} \qquad ( 5 )$$

In the translational direction according to equation (1), the following can be derived from Newton's laws:
the sum of the movement resistances (F_{w}),
products of the wheel contact forces Qi (calculated in the vertical force calculating module 20) and the coefficients of adhesion μᵢ,
coupling forces F_{Kup1} between carriage bodies, wherein the coupling forces, provided they are not measured, can alternatively be neglected, and
the product of mass M and acceleration \ddot{S}.

The mass M is made up of a static portion which is known from the engineering and an operational portion which can be measured by way of spring forces of the carriage body.

In the rotational direction, the following can be derived, by including equations (2) to (5):
the resultant axle-related motor torque values m_e_i, which result from the electric motor drive torques and braking torques, wherein the motor torques m_e_i can be calculated, for example, from the electrical variables of the motor,
the pneumatic braking torques m_p_i,
which the friction braking torque calculating module generates,
a moment based upon the wheel contact force Qi (calculated in the vertical force calculating module 20), the coefficient of adhesion μᵢ, and the wheel radius rᵢ, and
the product of the moments of inertia Iᵢ and the wheelset accelerations \dot{ω}ₜ, wherein the moments of inertia Iᵢ
of the axles are known from the engineering and the wheelset accelerations which can be determined by derivation of the axle rotary speeds.

The movement equations are fed into the state-space representation and made available to the Kalman filter 30 as a mathematical boundary condition:

$$\vec{x} = f ( \vec{x} , \vec{u} ) ,$$

$$where$$

$$\vec{u} = [ {m \_ p}_{1} , {m \_ p}_{2} , {m \_ p}_{3} , {m \_ p}_{4} , {Q}_{1} , {Q}_{2} , {Q}_{3} , {Q}_{4} , {m \_ e}_{1} , {m \_ e}_{2} , {m \_ e}_{3} , {m \_ e}_{4} , {r}_{1} , {r}_{2} , {r}_{3} , {r}_{4} ]$$

$$and$$

$$\vec{x} = [ {ω}_{1} , {ω}_{2} , {ω}_{3} , {ω}_{4} , {μ}_{1} , {μ}_{2} , {μ}_{3} , {μ}_{4} , \dot{s} ]$$

it follows that

$$\dot{\vec{x}} = ( \begin{matrix}\begin{matrix}\begin{matrix}\begin{matrix}\begin{matrix}\begin{matrix}\begin{matrix}\begin{matrix}\frac{1}{{I}_{1}} ( u ( 1 ) + u ( 5 ) x ( 5 ) u ( 13 ) + u ( 9 ) \\ \frac{1}{{I}_{2}} ( u ( 2 ) + u ( 6 ) x ( 6 ) u ( 14 ) + u ( 10 )\end{matrix} \\ \frac{1}{{I}_{3}} ( u ( 3 ) + u ( 7 ) x ( 7 ) u ( 15 ) + u ( 11 )\end{matrix} \\ \frac{1}{{I}_{4}} ( u ( 4 ) + u ( 8 ) x ( 8 ) u ( 16 ) + u ( 12 )\end{matrix} \\ 0\end{matrix} \\ 0\end{matrix} \\ 0\end{matrix} \\ 0\end{matrix} \\ \frac{1}{M} ( … {x ( 9 )}^{2} + u ( 9 ) + u ( 5 ) x ( 5 ) + u ( 6 ) x ( 6 ) + u ( 7 ) x ( 7 ) + u ( 8 ) x ( 8 ) )\end{matrix} )$$

The state vector \vec{x} has n=9 states and the process noise has the dimension Q^{(9×9)} wherein the diagonal entries of the matrix are occupied.

What are measured and fed back to the Kalman filter 30 as observations are the wheel rotary speeds ωᵢ, wherein m=4 observations are available. There results an observation matrix H^{(4×9)} and a diagonally populated covariance matrix of the measurement noise R^{(4×4)}.

The diagonal entries of the covariance matrix and of the process noise matrix are preferably determined empirically.

From the inputs (\vec{x}, \vec{u}), the Kalman filter 30 estimates, as traction values, the current coefficients of adhesion and a speed v_k, which is referred to below as the Kalman speed.

From the wheel rotary speeds ωᵢ and the wheel radii r_i, the slip module 40 calculates the axle speed value v_circulate according to:
in braking operation (recognized through the sum of the friction braking torque values and the motor torque values), the fastest axle defines the axle speed value.
in driving operation, the slowest axle defines the axle speed value.

In addition, with the aid of the speed fed back and/or the estimated movement value v_virt, the state “actual_sliding” is determined. This state expresses whether the vehicle is in all-axle sliding. For this purpose, the following criteria are made use of:
the variance of the axle rotary speeds,
the first time derivative of the axle rotary speeds,
the second time derivative of the axle rotary speeds and
the slip deviation of the axle rotary speeds from a reference speed which can correspond, for example, to the last determined estimated speed value v_virt.

In the evaluating module 50, the new estimated speed value v_virt and, as the new estimated acceleration value a_virt, the time derivative thereof are formed from the Kalman speed v_k and the axle speed value, preferably according to:
in the absence of all-axle sliding (actual_sliding=0), the axle speed value (v_circulate) defines the estimated speed value v_virt. 13
if all-axle sliding is present (actual_sliding=1), the Kalman speed v_k for the new estimated speed value v_virt is used. For this purpose, the Kalman speed v_k is freed from an offset in that it is “raised” or “reduced” to the last axle speed value (without all-axle sliding) and determines the new estimated speed value v_virt during the all-axle sliding.

Through differentiation and smoothing of the new estimated speed value v_virt, the new estimated acceleration value a_virt which can be used for plausibility checking the measured vehicle acceleration is formed.

Summarizing, on the basis of the brake cylinder pressures, the motor torques, the dynamic wheel diameters and the wheel rotary speeds, the estimating device 1 can determine the non-measurable coefficients of adhesion and new estimated speed values v_virt and new estimated acceleration values a_virt which can be used, for example, for plausibility checking a measured vehicle acceleration.

By way of a regulator arranged downstream, with the estimated coefficients of adhesion per wheel set and the speed (that is, the estimated movement value v_virt), a slip can be set so that the largest possible coefficients of adhesion come about. What is achieved thereby is a minimization of the stopping distance and/or a maximization of the traction force.

The estimated acceleration value a_virt can be used—as mentioned above—for plausibility checking of the measured acceleration. By way of this diversified redundancy, either the safety level can be increased or the installation of additional hardware can be dispensed with and/or a stronger weighting of the measurement values from the installed sensors can take place.

In addition, the new estimated speed value v_virt can be used in order to adapt the time between the recognition of the all-axle sliding and the triggering of the drift prevention. The drift prevention is preferably not carried out after a fixed time, but when the difference between the “classic” reference speed, that is the gradient-limited axle speed, and the estimated speed value v_virt exceeds a pre-determined value. Thereby, both inadmissibly large slip values and also unnecessary unbraking of the axles can be prevented.

The estimating device 1 also enables, for example, acceleration sensors, GPS or radar data to be weighted more strongly for the reference speed determination since they can be plausibility checked with a diversified redundant method by way of existing data. In addition, a more exact estimation of the coefficient of adhesion is enabled, which results in an optimization of the coefficient of adhesion utilization in slip regulation in the case of traction and braking.

In addition, the drift prevention intervention can take place adapted to the environmental conditions so that the accuracy of the reference speed can be increased and the stopping distance can be shortened.

FIG. 2 shows, by way of example, the implementation of the estimating device 1 according to FIG. 1 in a computing system 100 which forms, or at least also forms, the estimating device 1. The computing system 100, and therewith the estimating device 1, comprise a computing device 110 and a memory store 120 in which are stored a Kalman filter software module M30 which, when executed by the computing device, forms the Kalman filter 30 according to FIG. 1, a slip software module M40 which, when executed by the computing device, forms the slip module 40 according to FIG. 1, and an evaluating software module M50 which, when executed by the computing device, forms the evaluating module 50 according to FIG. 1.

Additionally stored in the memory store 120 are a vertical force calculating software module M20 which, when executed by the computing device, forms the vertical force calculating module 20 according to FIG. 1, and a friction braking torque calculating software module M10 which, when executed by the computing device, forms the friction braking torque calculating module 10 according to FIG. 1.

FIG. 3 shows an exemplary embodiment of a rail vehicle which is equipped with a computing system 100 according to FIG. 2 and thus with an estimating device 1 according to FIG. 1.

The rail vehicle 200 also comprises a slip regulator 210 which, by taking account of the estimated traction values μ_i per axle, the wheel circumferential speed values and the respective estimated movement value v_virt from the estimating device 1, regulates the slip of the respective axle.

Also connected to the estimating device 1 is a plausibility checking device 220 which carries out, with the estimated movement values from the estimating device 1, a plausibility check in relation to movement information from other sources.

Finally, it should be mentioned that the features of all the exemplary embodiments described above can be combined in any desired manner in order to form other exemplary embodiments of the invention.

All the features of subclaims can also each be combined with each of the independent claims, specifically each alone or in any desired combination with one or the other claims in order to obtain further exemplary embodiments.

1-15. (canceled)

16. An estimating device for determining a new estimated movement value which indicates a speed of a rail vehicle that has at least two axles, the estimating device comprising:
a Kalman filter to be supplied, on an input side, with a plurality of input values including torque values, vertical force values, wheel size values, and wheel rotary speed values, and said Kalman filter being configured, on a basis of the input values and on a basis of a Kalman filtration, to determine a Kalman-estimated vehicle speed value;
a slip module to be supplied, on an input side, with the torque values, the wheel size values, the wheel rotary speed values, and a respective prior estimated movement value from the estimating device, and said slip module being configured to determine a wheel circumferential speed value and a sliding indication which indicates any sliding of a respective axle of the rail vehicle; and
an evaluating module configured to determine a new estimated movement value of the estimating device on a basis of the Kalman-estimated vehicle speed value, the wheel circumferential speed value, and the sliding indications.

17. The estimating device according to claim 16, wherein said slip module is configured:
during a braking operation of the rail vehicle, to output the wheel circumferential speed value of an axle with a highest wheel circumferential speed value to said evaluating module;
during a driving operation, to output the wheel circumferential speed value of an axle with a smallest wheel circumferential speed value to said evaluating module; and
during a sliding of all the axles, to output an all-sliding indication to said evaluating module.

18. The estimating device according to claim 17, wherein said evaluating module is configured:
during a braking or driving operation of the rail vehicle and no sliding of all the axles, to output the wheel circumferential speed value as the new estimated movement value; and
during a sliding of all the axles, to determine the new estimated movement value on a basis of the Kalman-estimated vehicle speed value of the Kalman filter.

19. The estimating device according to claim 16, which further comprises:
a vertical force calculating module configured to generate, at least on a basis of the torque values that are also used by the Kalman filter, the wheel size values, and the respective prior estimated movement value of the estimating device, a vertical force value per axle; and
wherein each of the vertical force values of the vertical force calculating module forms one of the vertical force values to be used by the Kalman filter.

20. The estimating device according to claim 16, which further comprises:
a friction braking torque calculating module configured to generate, at least on a basis of a braking pressure value per axle, the wheel size values, and the respective prior estimated movement value of the estimating device, a friction braking torque value per axle; and
wherein each of the friction braking torque values forms one of the torque values to be used by the Kalman filter.

21. The estimating device according to claim 16, wherein the Kalman filter uses axle-related motor torque values as torque values or takes the axle-related motor torque values into account.

22. The estimating device according to claim 16, wherein the Kalman filter is an extended Kalman filter.

23. The estimating device according to claim 16, wherein the estimating device is configured to output, as a further estimated movement value, a vehicle acceleration value indicating an acceleration of the rail vehicle.

24. The estimating device according to claim 16, wherein:
the Kalman filter is configured to also determine a traction value relating to a force-rail contact per axle; and
the estimating device is configured to output the traction values.

25. The estimating device according to claim 16, which comprises a computer and a memory connected to said computer, said memory having stored therein:
a Kalman filter software module which, when executed by said computer, forms the Kalman filter;
a slip software module which, when executed by said computer, forms the slip module; and
an evaluating software module which, when executed by said computer, forms the evaluating module.

26. The estimating device according to claim 25, wherein said memory has stored therein:
a vertical force calculating software module which, when executed by said computer, forms a vertical force calculating module; and/or
a friction braking torque calculating software module which, when executed by said computer, forms a friction braking torque calculating module.

27. A rail vehicle, comprising an estimating device according to claim 16.

28. The rail vehicle according to claim 27, which further comprises a slip regulator connected to said estimating device, said slip regulator being configured to regulate the slip of the respective axle while taking into account the estimated traction values per axle, the wheel circumferential speed values, and the respective estimated movement value from said estimating device.

29. The rail vehicle according to claim 27, which further comprises a plausibility checking device connected to said estimating device, said plausibility checking device being configured to carry out, with the estimated movement values from the estimating device, a plausibility check in relation to movement information from other sources.

30. A method for determining a new estimated movement value which indicates a speed of a rail vehicle having at least two axles,
the method comprising:
supplying to an input side of a Kalman filter input values, including at least torque values, vertical force values, wheel size values, and wheel rotary speed values, and, based on the input values and based on a Kalman filtration, determining a Kalman-estimated vehicle speed value;
determining with the wheel size values, the wheel rotary speed values, and a respective prior estimated movement value, a wheel circumferential speed value and a sliding indication which indicates any sliding of a respective axle; and
determining a new estimated movement value on a basis of the Kalman-estimated vehicle speed value, the wheel circumferential speed value, and the sliding indications.
